(19) United States
(12) Patent Application Publication
(10) Pub. No.: US 2023/0039803 A1
(43) Pub. Date: Feb. 9, 2023

(54) PRELOADED TENSIONER DEVICE AND BELT ASSEMBLY

(71) Applicant: GATES CORPORATION, Denver, CO (US)

(72) Inventors: Anthony R. Mora, Waterford, MI (US); Alexander Serkh, Troy, MI (US); Thomas Lovin, Troy, MI (US); Nicholas P. Dougherty, Clarkston, MI (US); David P. Rieland, Troy, MI (US); Brett Bertrand, Tecumseh (CA)

(21) Appl. No.: 17/789,771

(22) PCT Filed: Jan. 8, 2021
(86) PCT No.: PCT/US2021/012565

§ 371 Date: Jun. 28, 2022

Related U.S. Application Data
(60) Provisional application No. 62/958,405, filed on Jan. 8, 2020.

(51) Int. Cl. F16H 7/12; F16H 7/20

(52) U.S. Cl. CPC F16H 7/1218; F16H 7/20; F16H 2007/081

(57) ABSTRACT

Described herein is a tensioner device, and assemblies and methods of manufacture thereof. The tensioner device may be adapted to create a target tension in an associated belt based on the measured length of the belt. The tensioner device may include an engagement member having a surface adapted to engage the belt and a biasing element associated with the engagement member. The biasing element has a loaded configuration that causes the engagement member to exert a force on the belt to create the target tension. In one example, the biasing element is manipulated into a loaded configuration so that the biasing element exhibits a deflection and an effective spring rate for creating the target tension. The belt may be trapped within the tensioner device with a bracket assembly enclosing one or more runs of belt relative to the engagement member.

### FIELD

The present invention relates generally to a belt tensioner, and more particularly to systems and techniques for adapting a tensioner to the characteristics of an associated belt.

### BACKGROUND

Belt tensioners are used to impart a load on a belt. The belt load prevents the belt from slipping on one or more entrained pulleys during operation. Typically, the belt is used in an engine application for driving various accessories associated with the engine. For example, an air conditioning compressor and alternator are two of the accessories that may be driven by a belt drive system.

A belt tensioner comprises a pulley journalled to an arm. A spring is connected between the arm and a base. The spring may also engage a damping mechanism. The damping mechanism comprises frictional surfaces in contact with each other. The damping mechanism damps an oscillatory movement of the arm caused by operation of the belt drive. This in turn enhances belt life expectancy.

In order to increase fuel economy and efficiency, many automotive manufacturers are beginning to incorporate alternators with the capability to drive the accessory belt drive system (ABDS). Such alternators are commonly referred to motor generator units (MGU's) or belt starter generators (BSG's). These may be used to start the engine, charge the battery, or boost the vehicle. During standard operation, the crankshaft pulley drives the ABDS. When this is the case, the tight side is the side of the belt that is entering the crankshaft pulley from the MGU, and the slack side is the side that is coming off of the crankshaft pulley and going toward the MGU. However, when the MGU is used to drive the system (such as during starting), the tight side becomes the side of the belt entering the MGU from the crankshaft pulley, and the slack side is the side of the belt leaving the MGU and entering the crankshaft pulley.

Accessory belts may have a range of acceptable length tolerances that may result in belt tensioners imparting different preloads to the belt than they were nominally designed to create because of the differing lengths of the belt. The variation in belt lengths (even within acceptable tolerances) may cause large differences in belt tension, tensioner performance, and component life. As such, the need continues for systems and techniques to tune the tensioner to the characteristics of an associated belt with which the tensioner is associated.

### SUMMARY

Examples of the present invention are directed to a tensioner device, and assemblies and methods manufacture thereof.

In one example, a tensioner device for creating a target tension in a belt is disclosed. The tensioner device includes an engagement member having a surface adapted to engage the belt. The tensioner device further includes a biasing element having a first portion and a second portion. The first portion of the biasing element is associated with the engagement member, and the second portion of the biasing element is associated with a retainer of the tensioner device. The tensioner device further includes a bracket assembly extending from opposing sides of the engagement member and encompassing a run of the belt, thereby securing the belt with the tensioner device. The biasing element is arranged with the tensioner device to store energy that is used by the engagement member to tension the belt.

In another example, a belt assembly is disclosed. The assembly includes a belt having a measured length. The assembly further includes a tensioner device configured to engage the belt and define a target tension in the belt, wherein the tensioner device includes an engagement member, a biasing element, and a retainer, wherein the biasing element is arranged in a loaded configuration relative to the engagement member and the retainer that corresponds to the measured length of the belt to create the target tension in the belt when the belt is engaged by the tensioner device.

In another example, a method of manufacturing a tensioner device and belt assembly is disclosed. The method includes measuring a length of a belt. The method includes associating the belt with a tensioner device. The tensioner device includes an engagement member adapted to engage the belt to define a target tension in the belt in a static configuration. The tensioner device also includes a biasing element associated with the engagement member and retainer. The method further includes manipulating the biasing element into a loaded configuration relative to the engagement member and the retainer. The loaded configured corresponds to the measured length of the belt to create the target tension in the belt when the belt is engaged by the tensioner device.

In addition to the exemplary aspects and examples described above, further aspects and examples will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts a sample tensioner device and belt assembly;

FIG. 2A depicts the tensioner device and belt assembly in a first configuration;

FIG. 2B depicts the tensioner device and belt assembly in a second configuration;

FIG. 2C depicts the tensioner device and belt assembly in a third configuration;

FIG. 3 depicts an exploded view of an example of the tensioner device;

FIG. 4A depicts a cross-sectional view of an engagement member and a bearing of a first subassembly of the tensioner device, taken along line I-I of FIG. 1;

FIG. 4B depicts a cross-sectional view of an engagement and a bearing of a second subassembly of the tensioner device, taken along line II-II of FIG. 1;

FIG. 5 depicts a sprocket arm of the first subassembly of the tensioner device;

FIG. 6A depicts a cross-sectional view of the first subassembly of the tensioner device including first and second sprocket arms, taken along line I-I of FIG. 1;

FIG. 6B depicts a cross-sectional view of the second subassembly of the tensioner device including first and second sprocket arms, taken along line II-II of FIG. 1;

FIG. 7A depicts a cross-sectional view of the first subassembly of the tensioner device including first and second bushings, taken along line I-I of FIG. 1;

FIG. 7B depicts a cross-sectional view of the second subassembly of the tensioner device including first and second bushings, taken along line II-II of FIG. 1;

FIG. 8 depicts a biasing element and a sprocket of the tensioner device;

FIG. 9A depicts a cross-sectional view of the first subassembly of the tensioner device including the biasing element and sprocket of FIG. 8, taken along line I-I of FIG. 1;

FIG. 9B depicts a bottom isometric view of the sprocket arm including engagement features for the biasing element;

FIG. 10 depicts a cross-sectional view of the second subassembly of the tensioner device including a sprocket;

FIG. 11 depicts a bottom view of the first subassembly of the tensioner device and the second subassembly of the tensioner device connected by a retainer;

FIG. 12 depicts a cross-sectional view of the first subassembly of the tensioner device and the second subassembly of the tensioner device connected by the retainer of FIG. 11 and a bracket, taken along line IV-IV of FIG. 1;

FIG. 13 depicts the tensioner device of FIG. 12 associated with a belt;

FIG. 14 depicts a cross-sectional view of the tensioner device of FIG. 13 with the belt trapped within the tensioner device by the bracket assembly, taken along line IV-IV of FIG. 1;

FIG. 15 depicts another sample tensioner device and belt assembly;

FIG. 16A depicts the tensioner device and belt assembly in a first configuration;

FIG. 16B depicts the tensioner device and belt assembly in a second configuration;

FIG. 16C depicts the tensioner device and belt assembly in a third configuration;

FIG. 17 depicts an exploded view of the tensioner device;

FIG. 18 depicts a top isometric view of the tensioner device;

FIG. 19 depicts a bottom view of the tensioner device;

FIG. 20A depicts a cross-sectional view of the tensioner device of FIG. 18, taken along line 20A-20A of FIG. 18;

FIG. 20B depicts a cross-sectional view of the tensioner device of FIG. 19, taken along line 20B-20B of FIG. 19;

FIG. 21 depicts a diagram showing relationships between torque and belt tension for various belt lengths;

FIG. 22 depicts another diagram showing relationship between torque and belt tensioner for various belt lengths; and

FIG. 23 depicts a flow diagram for manufacturing a tensioner device and belt assembly.

### DETAILED DESCRIPTION

The description that follows includes sample systems, methods, and apparatuses that embody various elements of the present disclosure. However, it should be understood that the described disclosure may be practiced in a variety of forms in addition to those described herein.

Before referring to the Figures, a brief explanation is provided. The present disclosure describes tensioner devices, and assemblies and methods of manufacture thereof. A sample tensioner device of the present disclosure may be associated with a belt having a measured length. The tensioner device may be tuned to match the characteristics of the specific belt with which the tensioner device is associated. For example, the tensioner device may have a biasing element manipulated into a loaded configuration within the tensioner device. The loaded configuration may correspond to an arrangement of the biasing element that is tuned to allow the tensioner device to create a target tension in the associated belt. Accessory belts generally have a range of acceptable length tolerances. Tensioners that merely include biasing elements set to a nominal belt length thus fail to account for different belt lengths because of the acceptable tolerances, which may produce inappropriate belt tensions and contribute to increased wear and reduced belt life.

The tensioner devices, assemblies, and methods of manufacture thereof of the present disclosure may mitigate such hindrances by tuning a tensioner device to accommodate the measured length of a belt with which the tensioner is associated. In this way, deviations from nominal belt length are accounted for, allowing the tensioner to exert a force on the belt that is tailored to the actual length of the belt. To facilitate the foregoing, the tensioner device generally includes a subassembly that is movably connected to a bracket assembly, such as in a pivotal or rotational arrangement. The subassembly is adapted to engage the belt and exert a force on the belt. At least one run of the belt is enclosed by the subassembly and the bracket, securing or trapping the belt within the tensioner device. With a specific belt having known or measured characteristics trapped within the tensioner device, the tensioner device may be constructed to create a target tension in the belt, notwithstanding nominal length variations.

In an example, the subassembly includes an engagement member, such as a pulley, that defines one or more surfaces that are adapted to engage the belt. The subassembly also includes a biasing element, such as a torsion spring or other biasing structure, that is connected with the engagement member in manner that causes the engagement member to exert a force on the belt to create the target tension therein. For example, the biasing element may be a torsion spring having a first end connected to the engagement member, and a second end connected to a retainer. The retainer may be, or include, a flexible elongated member that extends from the engagement member to another component of the tensioner device that is secured relative to the bracket. The torsion spring may be manipulated into a loaded configured relative to the engagement member and the retainer so that the torsion spring exhibits a deflection and an effective spring rate tailored for encouraging the engagement member to create the desired level of force on the belt. While many implementations are possible and contemplated herein, this may include arranging the first and second ends of the spring at an angular offset from one another, at least partially compressing the spring, based on the measured length of the belt.

The tensioner devices of the present disclosure may engage a single run of a belt. The tensioner devices of the present disclosure may also engage a first run and a second run of a belt, where the first and second runs form a continuous loop of the belt. When both runs are engaged, a tensioner device may enclose a single run of a belt, or may enclose both runs of the belt, in either case trapping the belt within the tensioner device. Alternatively, the tensioners of the present disclosure may be implemented such that they may not trap the belt within the tensioner, such as being arranged to releasably remove and replace a belt. It will be appreciated that sample structures are presented herein for engaging the belt and tuning the tensioner device with the appropriate tension, these are presented as examples, and in other cases, other structures may be implemented, as contemplated and described below.

Reference will now be made to the accompanying drawings, which assist in illustrating various features of the present disclosure. The following description is presented for purposes of illustration and description. Furthermore, the description is not intended to limit the inventive aspects to the forms disclosed herein. Consequently, variations and modifications commensurate with the following teachings, and skill and knowledge of the relevant art, are within the scope of the present inventive aspects.

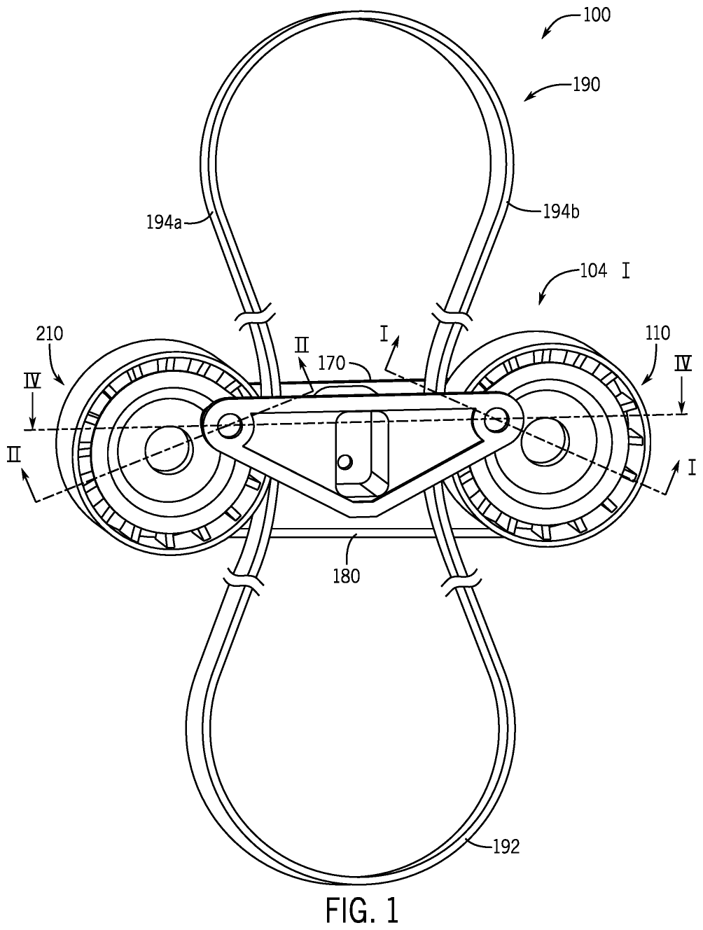

FIG. 1 depicts an assembly 100. The assembly 100 includes a tensioner device 104 and an associated belt 190, such as the tensioner device and belt discussed above and described in greater detail below. The belt 190 may be an accessory belt, such as that used in an engine application or otherwise for driving various accessories. The belt 190 is defined by a continuous loop 192 having a first run 194a and a second run 194b that cooperate to define the continuous loop 192 of the belt 190.

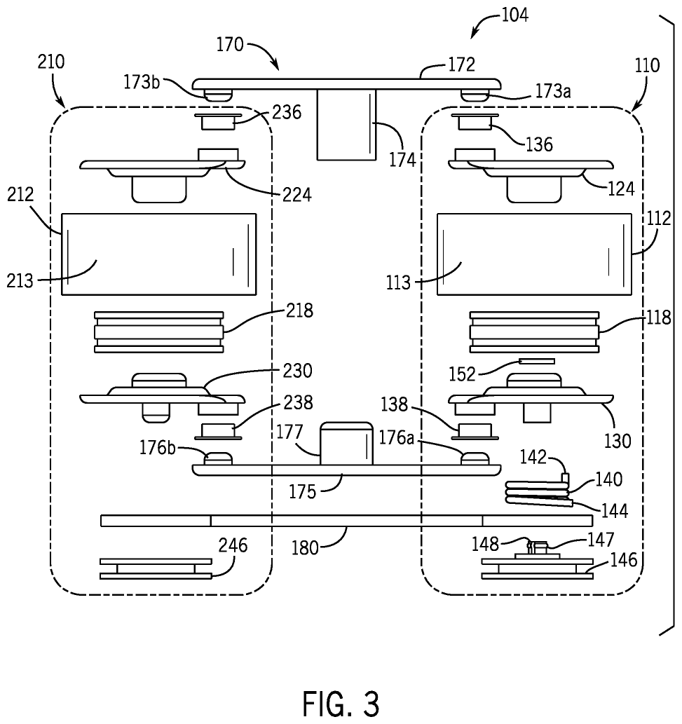

The tensioner device 104 may include a first subassembly 110 that is adapted to engage and exert a force on the first run 194a of the belt 190, and a second subassembly 210 that is adapted to engage and exert a force on the second run 194b of the belt 190. A bracket assembly 170 and a retainer 180 may connect the first and second subassemblies 110, 210 to one another. The subassemblies 110, 210 may pivot relative to the bracket assembly 170. The retainer 180 may generally facilitate control of one of the subassemblies 110, 210 relative to the other. The bracket assembly 170 cooperates with one or both of the subassemblies 110, 210 to enclose one or both runs 194a, 194b of the belt 190, securing the belt 190 within the tensioner device 104. One or more biasing elements (e.g., biasing element 140 of FIG. 3) of the tensioner device 104 may be associated with the subassemblies 110, 210 to encourage the pivoting or movement of the subassemblies 110, 210 toward the respective run 194a, 194b of the belt 190 to create a tension in the belt 190.

The assembly 100 is designed so that the belt 190 exhibits a target tension during operation using the tensioner device 104. The target tension may be a tension calculated for optimal performance of the belt 190 in an associated engine or other system. The belt 190 may have a nominal length, such as a length that is specified with respect to an engine design, e.g., a nominal length of 300 mm. The belt 190 may be manufactured with a range of acceptance belt length tolerances, e.g., a range of +/−4 mm, as one example. The assembly 100 is adapted to create the target tension in the belt 190 notwithstanding the length variance of the belt 190. For example, the subassemblies 110, 210 may be adapted to exert a force on the belt 190 that is based on a measured length of the belt 190, which accounts for the length variance. The belt 190 may be secured or trapped within the tensioner device 104 so that the specifically measured belt 190 remains associated with the tensioner device 104 that is tuned to that particular belt.

It will be appreciated, however, that the belt 190 may be separated from the tensioner device 104. For example, the tensioner device 104 may be partially disassembled in order to remove the belt. This may allow the belt 190 to be a component sold separately from the tensioner device 104, and the tensioner device 104 may be tuned to the characteristics of the belt 190. In this regard, where the belt 190 is secured or trapped within the tensioner device 104, the belt 190 may be disassociated from the tensioner device 104, such as may be desired for belt replacement and other maintenance activities. The replacement belt may have a different measured length than the previous belt, and thus the tensioner device 104 may be adjusted to create the target tension in the replacement belt according to the techniques described herein, such as manipulating the biasing element to exhibit a preload based on the measured length of the replacement belt.

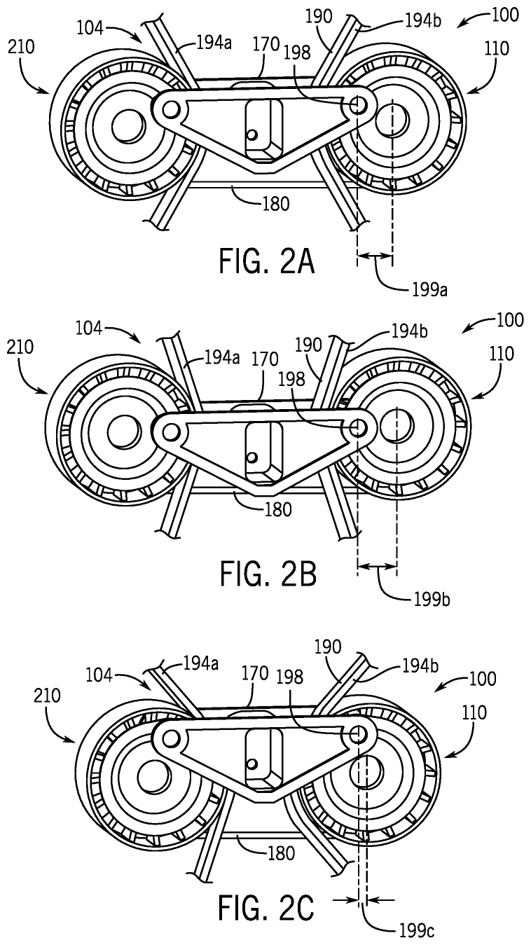

As shown in FIGS. 2A-2C, the subassemblies 110, 210 may exert a force on the belt 190 using different preload configurations of the biasing element based on the length of belt 190. For example, the subassemblies 110, 210 may exert a force on the belt 190 using the biasing element included therein and arranged in a loaded configuration that is tailored to bias the subassemblies 110, 210 for movement in an amount required to tension the belt 190 to the target tension based on the belt length.

To illustrate and with reference to FIG. 2A, the assembly 100 is shown in a first configuration in which the belt 190 has a nominal length. In the first configuration, the subassemblies 110, 210 exert a first force on the belt 190 to create the target tension in the belt 190. With reference to FIG. 2B, the assembly 100 is depicted in a second configuration in which the belt 190 has a measured length less than the nominal length, e.g., a “short” belt or negative length variation. In the second configuration, the subassemblies 110, 210 exert a second force on the belt 190 to create the target tension in the belt 190. With reference to FIG. 2C, the assembly 100 is depicted in a third configuration in which the belt 190 has a measured length greater than the nominal length, e.g., a “long” belt or positive length variation. In the third configuration, the subassemblies 110, 210 exert a third force on the belt 190 to create the target tension in the belt 190.

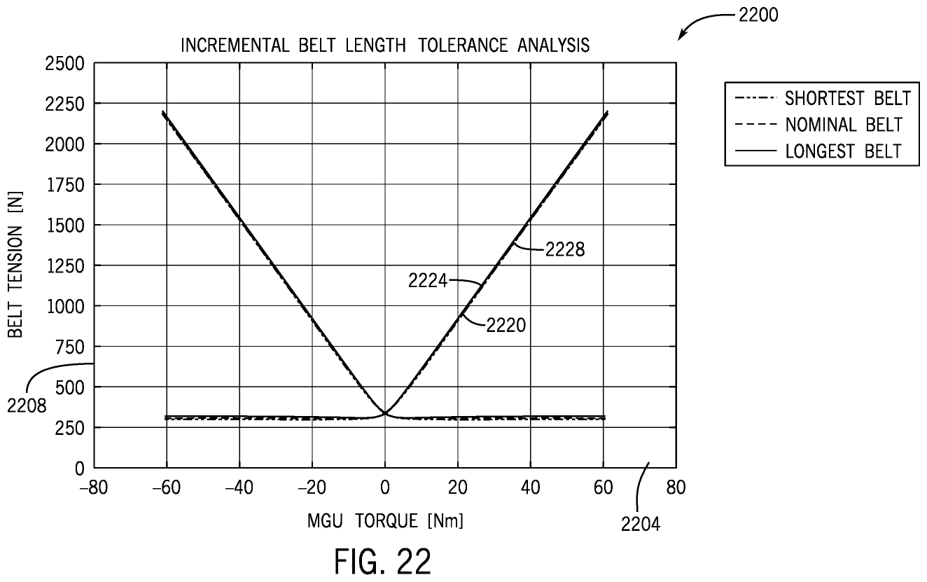

By tuning the tensioning device 104 to the length of the particular belt with which it is associated, (e.g. notwithstanding the differing lengths of the belts 190 in FIGS. 2A-2C), each belt 190 may exhibit the same target tension. More generally, the belts of FIGS. 2A-2C may generally operate according to the same tension v. torque characteristic (depicted in the diagram of FIG. 22), despite the belt 190 having different actual or measured lengths. In the first configuration of FIG. 2A, the first subassembly 110 may be positioned at an offset 199a from a pivot point 198 of the bracket assembly 170. In the second configuration of FIG. 2B, the first subassembly 110 may be positioned at an offset 199b from the pivot point 198. The shorter belt in the second configuration causes the first subassembly 110 to rotate away from the bracket assembly 170, and thus the offset 199b is greater than the offset 199a. And because the belt in the second configuration is shorter than the belt in the first configuration, it needs less force (from the subassemblies) in order to achieve the same tension. Further, in the third configuration of FIG. 2C, the first subassembly 110 may be positioned at an offset 199c from the pivot point 198. The longer belt in the third configuration causes the first subassembly 110 to rotate in towards the bracket assembly 170, and thus the offset 199c is less than the offset 199a. And because the belt in the third configuration is longer than the belt in the first configuration, it needs more force (from the subassemblies) in order to achieve the same tension. As explained in greater detail below, this is facilitated by manipulating a biasing element of the subassemblies 110, 210 to a loaded configuration that causes the subassemblies 110, 210 to have the appropriate force (e.g., the first force, the second force, the third force of FIGS. 2A-2C, and so on) so that the belt 190 is tensioned to the target tension.

Turning to FIG. 3, an exploded view of the tensioner device 104 is shown. The tensioner device 104 includes the first subassembly 110, the second subassembly 210, the bracket assembly 170, and the retainer 180. The first subassembly 110 includes an engagement member 112, such as a pulley, that has a surface 113 adapted to engage a length or run of the belt 190. The engagement member 112 is associated with a bearing 118 that is received within the engagement member 112. The first subassembly 110 includes an upper sprocket arm 124 and a lower sprocket arm 130 that are engagable with the bearing 118 at opposing sides of the engagement member 112. The first subassembly 110 may have a pair of bushing 136, 138 that are engagable with a respective one of the first and second sprocket arms 124, 130 and facilitate a connection between the first subassembly 110 and the bracket assembly 170, such as by establishing a pivot or rotational connection between each. The first subassembly 110 also includes a biasing element 140, which may be a torsion spring, as shown in FIG. 3; however, other biasing elements and structures are contemplated herein. The biasing element 140 includes a first end 142 associated with the engagement member 112 via the second sprocket arm 130, and a second end 144 associated with a sprocket 146. The sprocket 146 is a rotatable sprocket that includes a shaft 147 receivable by the second sprocket arm 130 to facilitate rotation relative thereto.

In some cases, a washer 152 may receive an end portion 148 of the shaft 147 to facilitate securing the sprocket 146 relative to the second sprocket arm 130 without substantially constraining relative rotational movement. It will be appreciated, however, that the washer 152 may be omitted, which may be desirable in order to reduce an overall part count and/or height of the shaft 147. Yet further, the washer 152 may be substituted for another mechanical component such as a pin, clip, or fastener to facilitate securing the shaft 147 without substantially constraining the relative rotational movement.

The second subassembly 210 may include somewhat analogous components as the first subassembly 110 and include an engagement member 212 with a surface 213, a bearing 218, an upper sprocket arm 224, a lower sprocket arm 230, and a pair of bushings 236, 238. In the example of FIG. 3, the second subassembly 210 does not include a biasing element as is included in the first subassembly 110. Further, the second subassembly 210 includes a sprocket 246 that is connected to, and generally fixed relative to, the second sprocket arm 230. In other examples, the sprocket 246 may be a non-fixed sprocket and therefore may be configured to rotate relative to the second sprocket arm 230. The sprocket 246 may be associated with a biasing element that is substantially analogous to the biasing element 140. In this regard, the sprocket 246 may be used in conjunction with the additional biasing element to move the engagement member 212 without departing from the spirit and scope of the invention.

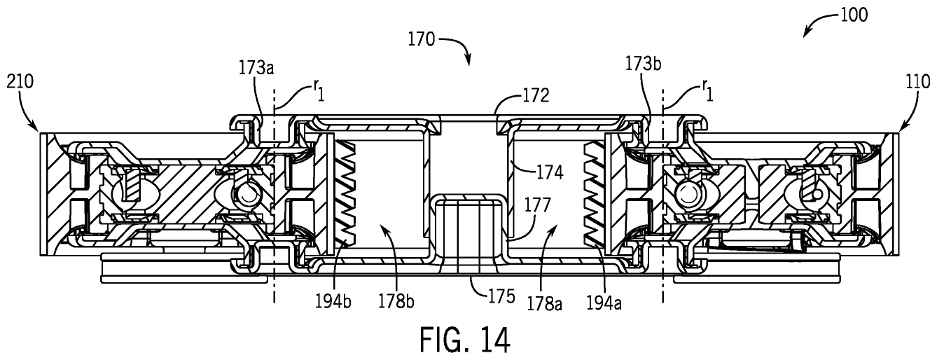

The bracket assembly 170 includes a first bracket 172 and a second bracket 175. In other cases, the bracket assembly 170 can include or be defined by a single, integrally formed component. In the example of FIG. 3, the first bracket 172 includes connection points 173a, 173b for pivotally engaging the respective first and second subassemblies 110, 210, and a mount 174 for engaging the second bracket 175. The second bracket 175 includes connection points 176a, 176b for pivotally engaging the respective first and second subassemblies 110, 210, and a mount 177 for engaging the first bracket 175. In an engaged configuration, the mount 174 of the first bracket 172 and the mount 177 of the second bracket 175 define a continuous and rigid connection between the first and second brackets 172, 175. Further in the engaged configuration (depicted in FIG. 14), a first passage 178a is defined by the first subassembly 110 and the mounts 174, 177 and the second passage 178b is defined by the second subassembly 210 and the mounts 174, 177. The first run 194a of the belt 194 may be arranged within the first passage 178a and the second run 194b of the belt 190 may be arranged with the second passage 178b, thereby securing the belt 190 within the tensioner device 104.

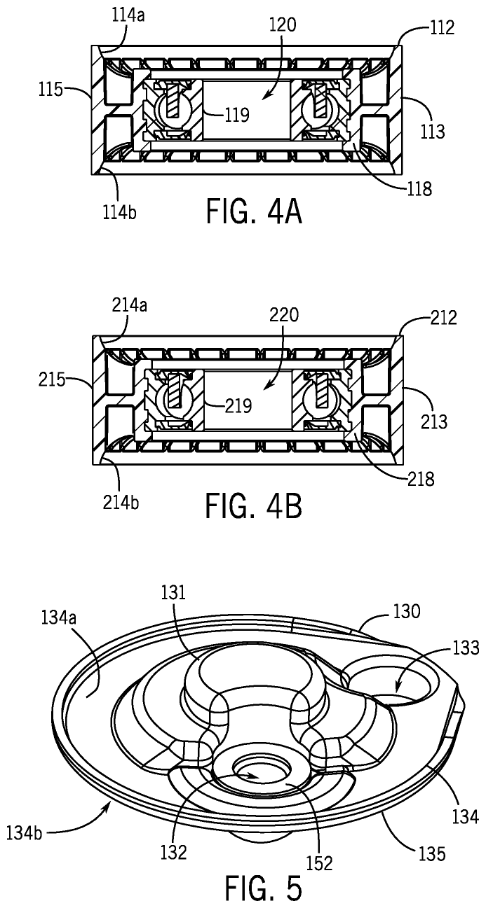

FIG. 4A depicts a cross-sectional view of the engagement member 112 and the bearing 118 of the first subassembly 110 of the tensioner device 104. The engagement member 112 may be a molded component that is molded over the bearing 118 in certain examples. An injection moldable plastic, or other material adaptable to a molding process, may be used to form the engagement member 112. A metal material may optionally be used to form the bearing 118. In other cases, the bearing 118 may be formed from a moldable material, such as being formed from a moldable material that is different from the moldable material used to form the engagement member 112.

The bearing member 118 may be received in or included in the engagement member 112. In some cases, the engagement member 112 may be molded over the bearing member 118. In other examples, the engagement member 112 may define a recess and the bearing member 118 may be press fit into the recess. The engagement member 112 may define an upper recess 114a and a lower recess 114b. The upper and lower recesses 114a, 114b may be adapted to receive one or more sprockets of the tensioner device 104, or other component that facilitates establishing a pivot between the engagement member 112 and other components of the tensioner device 104. The engagement member 112 is shown in FIG. 4A as having a wall 115. The wall may be a structural component of the engagement member 112. The wall 115 therefore may have a thickness tailored so that the engagement member 112 has a sufficient strength, rigidity, and/or other properties, such as may be desired for engaging the belt 194. More generally, the wall 115 also defines at least a portion of the surface 113, the upper and lower recesses 114a, 114b, and/or the interface between the engagement member 112 and the bearing 118.

The bearing 118 may have an interior surface 119. The interior wall may extend substantially through a thickness of the bearing so that the bearing 118 has a hollow interior, or otherwise defines a passage 120 there through. The hollow passage 120 may be adapted to receive one or more sprockets of the tensioner device 104, or other component that facilitates establishing a pivot between the engagement member 112 and other components of the tensioner device 104. The interior surface 119 may provide a friction or interference fit with such components, as described herein.

FIG. 4B depicts a cross-sectional view of the engagement member 212 and the bearing 218 of the second subassembly 210 of the tensioner device 104. The engagement member 212 and the bearing 218 may be substantially analogous to the engagement member 112 and the bearing 118 described in relation to FIG. 4A. In this regard, the engagement member 212 may include an upper recess 214a, a lower recess 214b, and a wall 215. Further, the bearing 218 may include an interior surface 219 and a passage 220.

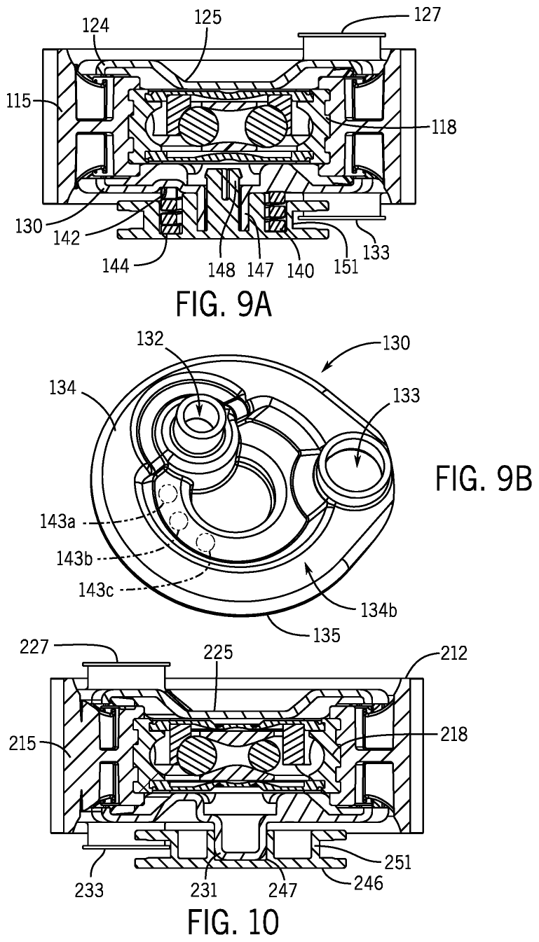

FIG. 5 depicts a lower sprocket arm 130 of the first subassembly 110 of the tensioner device 104. The lower sprocket arm 130 may include a main body 134 having a generally disc shape and defining a periphery 135. The main body 134 defines opposing faces, such as defining an upper face 134a and defining a lower face 134b. The main body 134 and may also be adapted to connect with the biasing element 140 at a variety of locations along a respective one of the faces 134a, 134b in order to define the preload in the biasing element 140 (e.g., as described in relation to FIGS. 8-9B). The lower sprocket arm 130 may define a post 131 extending from the upper face 134a. The post 131 may be generally concentrically arranged on the lower sprocket arm 130 and adapted to be received by the recess 120 of bearing 118. The lower sprocket arm 130 may further define a first aperture 132 and a second aperture 133. The first and second apertures 132, 133 may extend through a thickness of the lower sprocket arm 130. The first aperture 132 may be adapted to receive the sprocket 146 for rotation of the sprocket 146 relative to the lower sprocket arm 130. In one example, the washer 152 may be placed about the first aperture 132 to facilitate securing the sprocket 146 and the lower sprocket arm 130 while maintaining a rotational association of the sprocket 146 and the lower sprocket arm 130 to one another. The second aperture 133 may be adapted to define a pivotal engagement with the bracket assembly 170.

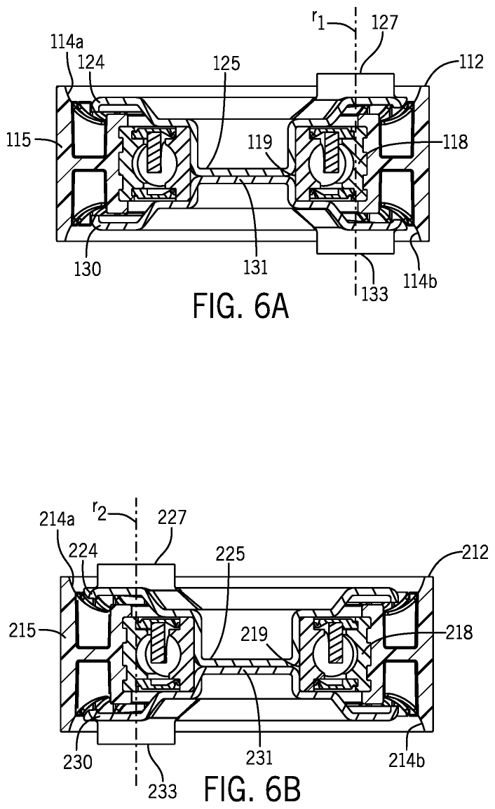

FIG. 6A depicts the first subassembly 110 of the tensioner device 104 in an assembled state with the upper sprocket arm 124 and the lower sprocket arm 130. In the assembled state, the upper sprocket arm 124 and the lower sprocket arm 130 are pressed into the passage 120 of the bearing 118. For example, the upper sprocket arm 124 may include a post 125 that is inserted at least partially into the passage 120. The post 125 may be used to establish a friction or interference fit with the interior surface 119 of the bearing 118. Further, the post 131 may also be inserted at least partially into the passage 120 and be used to establish a friction or interference fit with the interior surface 119 of the bearing 118. The upper and lower sprocket arms 124, 130 are also seated substantially within the upper and lower recesses 114a, 114b, respectively. Major surfaces of the upper and lower sprocket arm 124, 130 may therefore be substantially flush with the engagement member 112 at opposing ends of the engagement member 112, and/or include portions that are recessed from the opposing ends.

The upper and lower sprocket arms 124, 130 may be pressed into the passage 120 in a manner to establish a pivot axis r₁ that extends through the engagement member 112. For example, the upper sprocket 124 may define an aperture 127. The aperture 127 may be adapted to receive one or more components of the bracket assembly 170 for relative rotation therewith. The lower sprocket arm 130 includes the aperture 133 which is also adapted to receive one or more components of the bracket assembly 170 for relative rotation therewith. The apertures 127, 133 are aligned with one another on the pivot axis r₁. Accordingly, the apertures 127, 133 may cooperate with one another to allow the engagement member 112 to rotate relative to the bracket assembly 170 about the axis r₁.

FIG. 6B depicts the second subassembly 210 of the tensioner device 104 in an assembled state with the upper sprocket arm 224 and the lower sprocket arm 230. The upper sprocket arm 224 and the lower sprocket arm 230 may be arranged relative to the engagement 212 and bearing 218 in a manner substantially analogous to that described in FIG. 6A in relation to the first subassembly 110. In this regard, the upper sprocket arm 224 may define a post 225 and an aperture 227, and the lower sprocket arm 230 may define a post 231 and an aperture 233. Further, the apertures 227, 233 may cooperate with one another to allow the engagement member 212 to rotate relative to the bracket assembly about an axis r₂.

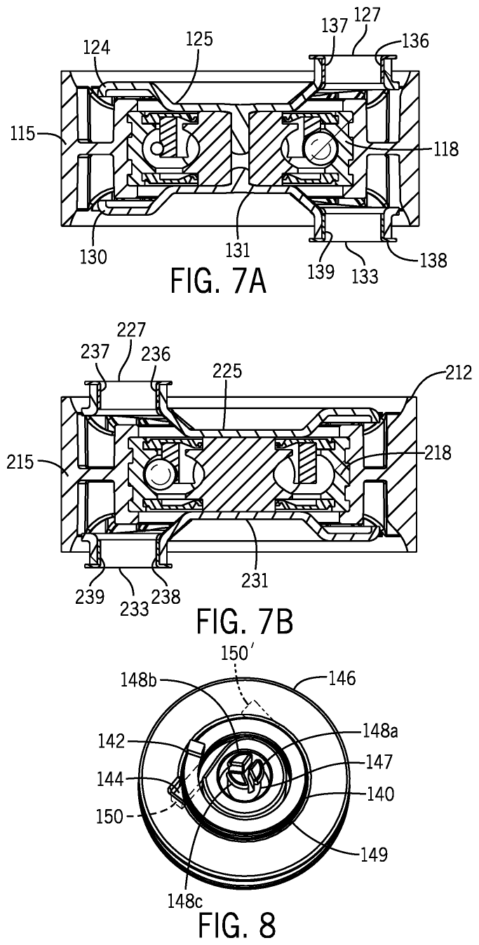

FIG. 7A depicts the first subassembly 110 of the tensioner device 104 including the first and second bushings 136, 138. The first bushing 136 may be received in the aperture 127 and the second bushing 138 may be received into the aperture 133. As one example, the first bushing 136 may have a bushing wall 137 that is adapted to engage a surface of the upper sprocket arm 124 at the aperture 127. Similarly, the second busing 138 may have a bushing wall 139 that is adapted to engage a surface of the lower sprocket arm 130 at the aperture 133. The engagement in either case may establish a friction or interference fit between the respective ones of the bushings 136, 138 and the upper and lower sprocket arms 124, 130.

FIG. 7B depicts the second subassembly 210 of the tensioner device 104 including the first and second bushings 236, 238. The first and second bushings 236, 238 may be arranged within the second subassembly 210 in a manner substantially analogous to that described in FIG. 7A in relation to the first subassembly 210, and include bushing walls 237, 239, respectively.

FIG. 8 depicts the biasing element 140 and the sprocket 146 of the tensioner device 104. The biasing element 140 may be installed in the sprocket 146 by seating the biasing element 140 into a receiving portion 149 of the sprocket 146. The biasing element 140 may be a torsion spring having a continuous coil that forms a cylindrical and hollow shape. The biasing element 140 may be seated in the receiving portion 149 in a manner in which the shaft 147 and the end portion 148 extend through the hollow portion of the cylindrical shape defined by the biasing element 140. The biasing element 140 may be secured and substantially positionally fixed within the sprocket 146 by fitting the second end 144 of the biasing element 140 (e.g., a tang) into a tang groove 150. In some cases, multiple grooves may be provided in the sprocket 146 in order to connect the biasing element 140 at an appropriate rotational position with the first subassembly 110. In the example of FIG. 8, an alternative tang groove 150′ is provided in the sprocket 146. The alternative tang groove 150′ may be arranged so that when the biasing element 140 is fitted therein, the biasing element 140 may be held or maintained in a loaded configuration in which the biasing element 140 exhibits a preload that corresponds to the measured length of the belt.

With reference to FIGS. 8 and 9, the biasing element 140 and the sprocket 146 may be operably engaged with the lower sprocket arm 130 of the first subassembly 110. For example, the sprocket 146 may be rotationally engaged with the lower sprocket arm 130, and the first end 142 of the biasing element 142 may be engaged with the lower sprocket arm 130 in order to exert a biasing force thereon as the sprocket 146 rotates. As one example, the sprocket 146 may be rotationally engaged with the lower sprocket arm 130 using the shaft 147 of the sprocket 146. This is shown in FIG. 9A, where the shaft 147 may be inserted through the aperture 132 of the lower sprocket arm 130. The shaft 147 may be inserted through the aperture 132 so that the end portion 148 extends fully through the aperture 132, and fully or partially through the washer 152. The end portion 148 may include a first end portion 148a, a second end portion 148b, and a third end portion 148c, each of which of which may be at least partially biased outward form one another at the tip or terminal end of the shaft 147. The first, second, and third end portions 148a, 148b, 148c may also include an overhang or other feature the substantially prevents exit of the sprocket 146 from the washer once the end portions 148a, 148b, 148c pass there through.

The first end 142 of the biasing element 140 may be positionally fixed relative to the lower sprocket arm 130. For example, the first end 142 may be received by a tang groove or other receiving feature of the lower sprocket arm 130 that generally prevents movement of the first end 142 relative to the lower sprocket arm 130. The sprocket 146 also defines a groove 151 along an exterior circumferential surface. The groove 151 may be adapted to receive the retainer 180, which as described herein, may be used to cause the sprocket 146 to rotate relative to the lower sprocket arm 130.

As shown in FIG. 9B, the lower sprocket arm 130 may optionally define multiple tang grooves or receiving features that generally prevent movement of the first end 142 relative to the lower sprocket arm 130. In this regard, the lower sprocket arm 130 can define an angular offset of the spring ends. In FIG. 9B, a first receiving features 143a, a second receiving feature 143b, and a third receiving feature 143c are shown. The multiple receiving features 143a, 143b, 143c may be provided in the lower sprocket arm 130 in order to connect the biasing element 140 at an appropriate rotational position with the first subassembly 110. In the example of FIG. 9B, the receiving features 143a, 143b, 143c may be arranged so that when the biasing element 140 is fitted therein, the biasing element 140 may be held or maintained in a loaded configuration in which the biasing element 140 exhibits a preload that corresponds to the measured length of the belt. For the sake of non-limiting example, the first end 142 may be associated with the receiving feature 143a to define a loaded configuration for the biasing element 140 when the tensioner device 104 is engaged with a short belt, the first end 142 may be associated with the receiving feature 143b to define a loaded configuration for the biasing element 140 when the tensioner device 104 is engaged with a nominal belt, and the first end 142 may be associated with the receiving feature 143c to define a loaded configuration for the biasing element 140 when the tensioner device 104 is engaged with a long belt. Other configurations are possible and contemplated herein, include where more or fewer receiving features, or no receiving features, are provided by the lower sprocket arm 130.

With reference to FIG. 10, the second subassembly 210 of the tensioner device 104 is depicted including the sprocket 246. The sprocket 246 is shown being fitted with the second sprocket arm 230. Generally, the sprocket 246 is fixed relative to the second sprocket arm 230. In this regard, the second sprocket arm 230 may include a protrusion 231 and the sprocket 246 may include a receiving feature 247. The protrusion 231 may be pressed into the receiving feature 247 in order to define a friction or interference fit between the second sprocket arm 230 and the sprocket 246, generally restricting relative movement there between. FIG. 10 also shows the sprocket 246 as including a groove 251. The groove 251 may be adapted to receive the retainer 180, such as receiving an opposite end of the retainer 180 than that received by the groove 110, to facilitate a linkage between the first and second subassemblies 110, 210.

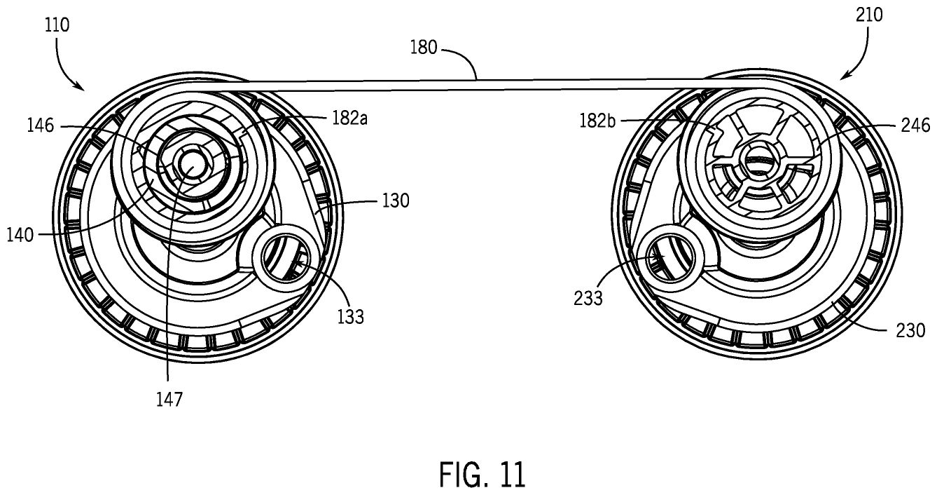

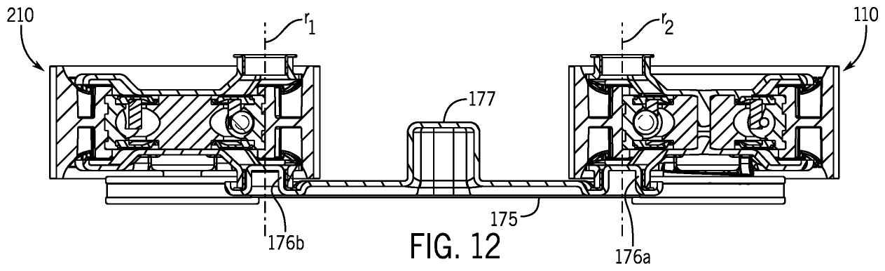

FIG. 11 depicts a bottom view of the first subassembly 110 of the tensioner device 104 and the second subassembly 210 of the tensioner device 104 where the subassemblies 110, 210 are connected by the retainer 180. For clarity, the retainer 180, the sprocket 146, and the sprocket 246 are shown in cross-section. The retainer 180 generally spans the tensioner device 104 and defines movement of the first and second sprocket 146, 246 relative to one another. More specifically, the retainer 180 may be used to define a rotational position of the sprocket 146 within the first subassembly 110, for example by lengthening or shortening a span of the retainer 180 between the first sprocket 146 and the second sprocket 246 (which is rotationally fixed relative to the second subassembly 210). As described herein, the retainer 180 may therefore be used to load the biasing element 140 to a desired preload as the rotation of the sprocket 146 may cause the biasing element 140 to compress and/or otherwise store energy.

To facilitate the foregoing, the retainer 180 may have a first end 182a and a second end 182b that is opposite the first end 182a. The retainer 180 may include or define an elongated flexible member between the first and second ends 182a, 182b. The first end 182a may be associated with the sprocket 146 and the second end 182b may be associated with the sprocket 246. For example, the first end 182a may be fixed to the sprocket 146 and the retainer 180 may be wrapped one, two, or more times around the sprocket 146 and within the groove 151. In some cases, the ends 182a, 182b of the retainer 180 may be wrapped around the respective sprocket in a helical or spiral shape. At least some portion of the respective sprocket may have a constant diameter, which may facilitate movement of the retainer 180 relative to the sprocket. As one example, the portion of the sprocket engaged with the retainer 180 can have a substantially constant diameter at around 120 degrees of its circumference. The retainer 180 may extend from the sprocket 146 to the sprocket 246. The second end 182b of the retainer 180 may be fixed to the sprocket 246, and the retainer 180 may be wrapped one, two, or more times around the sprocket 246 and within the groove 251.

FIG. 12 depicts a cross-sectional view of the first subassembly 110 and the second subassembly 210 connected by the retainer 180 and the bracket assembly 170. In FIG. 12, the second bracket 175 is associated with the lower sprocket 130 of the first subassembly 110 and the lower sprocket 230 of the second subassembly 210. For example, the connection point 176a may be inserted at least partially into the aperture 133 and the connection point 176b may be inserted at least partially into the aperture 233. The connection points 176a, 176b may be engagable with respective ones of the bushings 138, 238 within the apertures 133, 233 such that the first subassembly 110 is adapted to pivot relative to the bracket assembly 170, about the axis r₁, and such that the second subassembly 210 is adapted to pivot relative to the bracket assembly 170, about the axis r₂. The first and second subassemblies 110, 210 may therefore pivot relative to the bracket assembly 170 as needed to create the target tension in the belt, such as rotating to a position corresponding to one or more of the offsets 199a, 199b, 199c described above in relation to FIGS. 2A-2C.

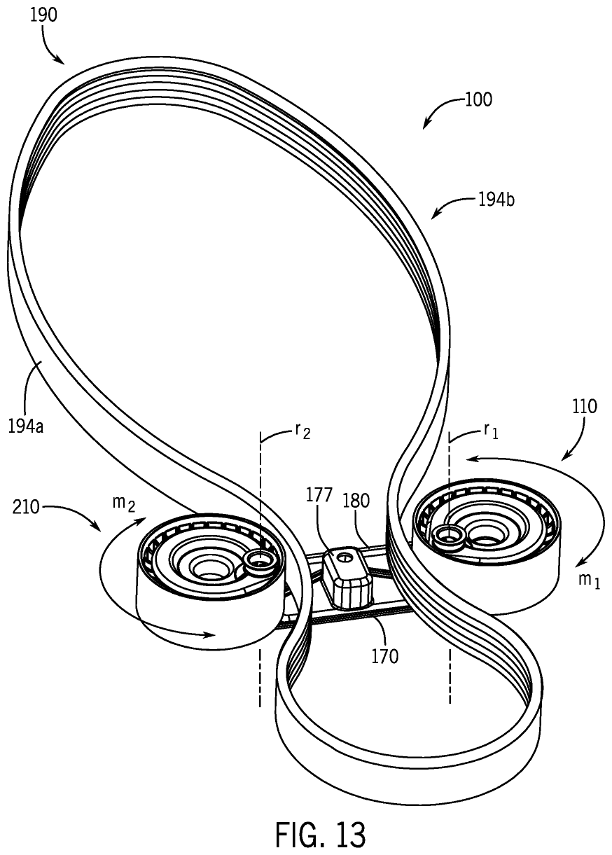

FIG. 13 depicts the tensioner device 104 of FIG. 12 associated with the belt 190. In FIG. 13, the first bracket 172 is omitted for clarity. The first run 194a of the belt 190 is positioned substantially between the mount 177 and the second subassembly 210, and a second run 194b of the belt 190 is positioned substantially between the mount 177 and the first subassembly 110. In this regard, the mount 177 extends through a center of the continuous loop 192 of the belt 190. In FIG. 13, the first subassembly 110 is adapted for movement m₁ about the axis r₁. Further, the second subassembly 210 is adapted for movement m₂ about the axis r₂.

FIG. 13 shows the association of a specific belt, e.g., the belt 190, with the tensioner device 104. Because a specific belt is associated with the tensioner device 104, a length of the belt 190 may be measured, and the tensioner device 104 adjusted accordingly. For example, the belt 190 has a nominal length, which includes tolerances that allow the measured length to be either longer or shorter than the nominal length. Thus, the measured length may include a positive or negative deviation from the nominal length of the belt 190. A laser, jig, or other measuring technique may be used to determine the measured or actual length of the belt 190 that is associated with the tensioner device 104. For example, the belt 190 may be placed in a circular jig after being formed into a loop and after cooling in order to determine a length of the belt. In other cases, the belt 190 may be measured end to end, such as being measured before being formed into a loop and/or after being formed into a loop with reference to a common starting and end point for the measurement.

With reference to FIGS. 9B and 11, the biasing element 140 may be tuned to a desired preload based on the measured length of the belt 190. For example, the first end 142 of the biasing element 140 may be manipulated into an angular offset relative to the second end 144 of the biasing element 140. The angular offset may correspond to a compression of the biasing element 140 that stores energy, which when released, exerts a force on the engagement member 112 that deflects the engagement member 112 inwardly relative to the bracket assembly 170 to apply tension to belt 190, which creates the desired tension. The angular offset is therefore tunable in order to increase or decrease the preload associated with the biasing element 140, such as where the preload is increased for a positive length deviation in belt 190 length, or decreased for negative deviation in belt 190 length.

In certain examples, such as that shown in FIG. 11, the retainer 180 may be used to tune the biasing element 140 and set the angular offset. For example, the retainer 180 may be fixed to the sprocket 146 at the first end 182a and used to rotate the sprocket 146 and thus change the angular offset of the first and second ends 142, 144 of the biasing 140. The retainer 180 may also be used to retain the angular offset (e.g., in a static configuration) based on the arrangement of the retainer 180 relative to the sprocket 146. For example, the retainer 180 extends from the sprocket 146 to the sprocket 246, where the retainer 180 is fixed at the second end 182b. The sprocket 246 may be fixed to the lower sprocket arm 230 in a manner such that the retainer 180 causes the sprocket 130 to hold the biasing element 140 in the angular position. For example, during installation, the sprocket 246 may be rotated so that the span or length of the retainer 180 may be effectively lengthened or shortened between the sprockets 146 and 246. This may correspondingly change an angular position of the sprocket 146, and thus the angular offset between the first and second ends 142, 144 of the biasing element 140. And thus when the appropriate position is reached, the sprocket 146 may be fixed to the lower sprocket arm 246, and the biasing element 140 may be maintained in a loaded configuration that corresponds to the measured length of the belt 190.

FIG. 14 depicts the tensioner device 104 of FIG. 13 with the belt 192 trapped within the tensioner device 104 by the bracket assembly 170. In FIG. 13, the first bracket 172 is associated with the upper sprocket 124 of the first subassembly 110 and the upper sprocket 224 of the second subassembly 210. For example, the connection point 173a may be inserted at least partially into the aperture 127 and the connection point 173b may be inserted at least partially into the aperture 227. The connection points 173a, 173b may be engagable with respective ones of the bushings 136, 236 within the apertures 127, 227 such that the first subassembly 110 is adapted to pivot relative to the bracket assembly 170, about the axis r₁, and such that the second subassembly 210 is adapted to pivot relative to the bracket assembly 170, about the axis r₂.

In the assembly configuration of FIG. 14, the bracket assembly 170 defines the first passage 178a with the first subassembly 110, and the second passage 178b with the second subassembly 210. The first run 194a of the belt 190 may extend through the first passage 178a and the second run 194b of the belt 190 may extend through the second passage 178b. In this regard, the bracket assembly 170 cooperates with the first and second subassembly 110, 210 to secure and trap the belt within the tensioner device 104.

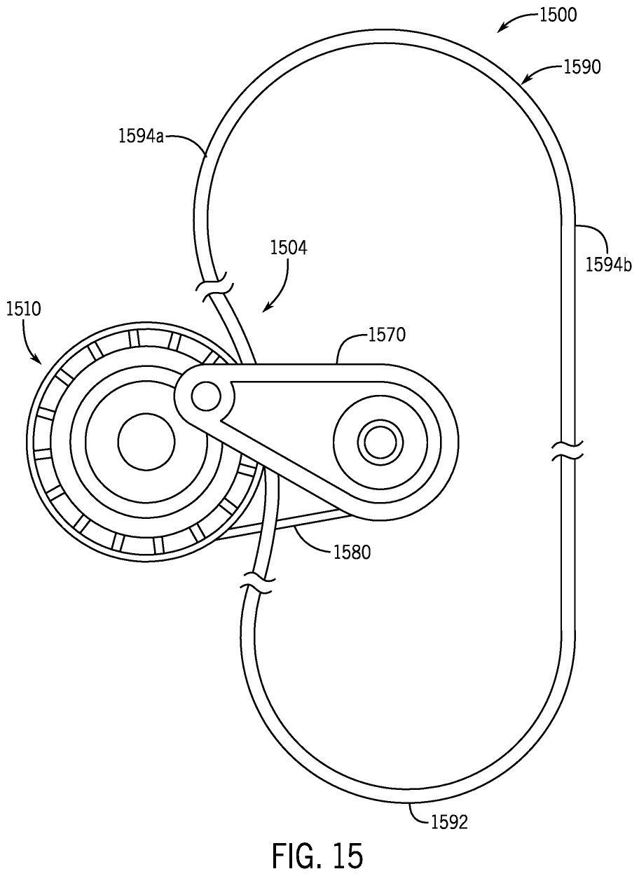

FIG. 15 depicts an additional example of a tensioner device and belt assembly. In the example of FIG. 15, a single run of the belt may be tensioned, and trapped, using the sample tensioner device. For example, FIG. 15 depicts an assembly 1500, which includes a tensioner device 1504 and an associated belt 1590. The belt 1590 may be substantially analogous to the belt 190 described herein, and as such, define a continuous loop 1592 having a first run 1594a and a second run 1594b that cooperate to define the continuous loop 1592 of the belt 1590.

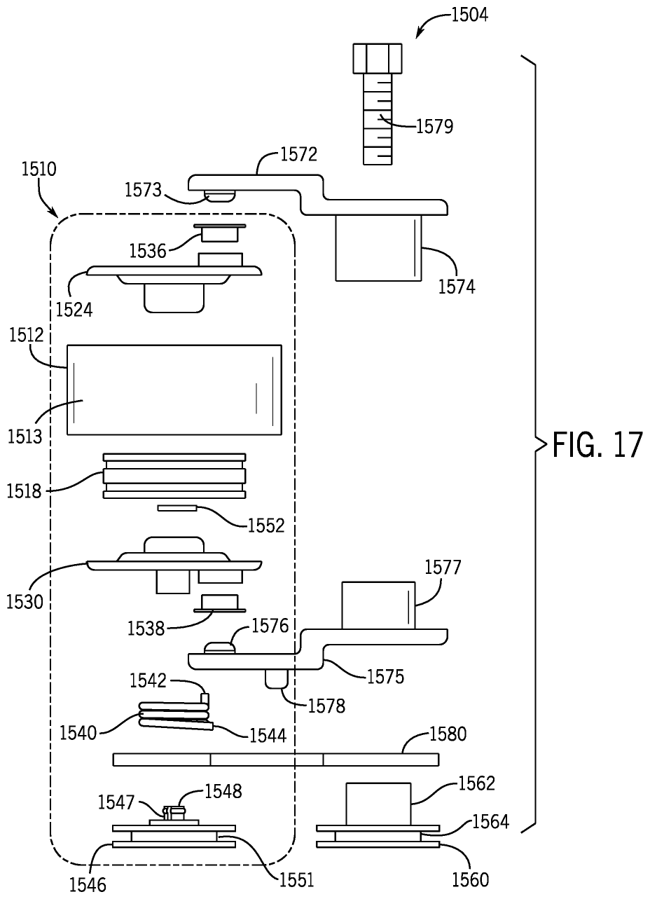

The tensioner device 1504 may include a subassembly 1510 that is adapted to engage and exert a force on the first run 1594a of the belt 1590. A bracket assembly 1570 and a retainer 1580 may connect the subassembly 1510 to a fixed, anti-rotation component, or other anchor within the assembly 100. The subassembly 1510 may pivot relative to the bracket assembly 1570. The retainer 1580 may generally facilitate control of one of the subassemblies 1510 relative to the bracket assembly 1570. The bracket assembly 1570 cooperates with the subassembly 1510 to enclose a run (e.g., the first run 1594a) of the belt 1590, securing the belt 1590 within the tensioner device 1504. One or more biasing elements (e.g., biasing element 1540 of FIG. 17) of the tensioner device 1504 may be associated with the subassembly 1510 to encourage the pivoting or movement of the subassembly 1510 toward the respective run of the belt 1590 to create a tension in the belt 1590.

The assembly 1500 is designed so that the belt 1590 exhibits a target tension during operation using the tensioner device 1504. The target tension may be a tension calculated for optimal performance of the belt 1590 in an associated engine or other system. The assembly 1500 is adapted to create the target tension in the belt 1590, notwithstanding length variances of the belt 1590. For example, the subassembly 1510 may be adapted to exert a force on the belt 1590 that is based on a measured length of the belt 1590, which accounts for the length variance. The belt 1590 may be secured or trapped within the tensioner device 104 so that the specifically measured belt 1590 remains associated with the tensioner device 1504 that is tuned to that particular belt. It will be appreciated, however, that the belt 1590 may be separated from the tensioner device 1504. For example, the belt 1590 may be a component sold separately from the tensioner device 1504, and the tensioner device 1504 may be tuned to the characteristics of the belt 1590. In this regard, where the belt 1590 is secured or trapped within the tensioner device 1504, the belt 1590 may be disassociated from the tensioner device 1504, such as may be desired for belt replacement and other maintenance activities.

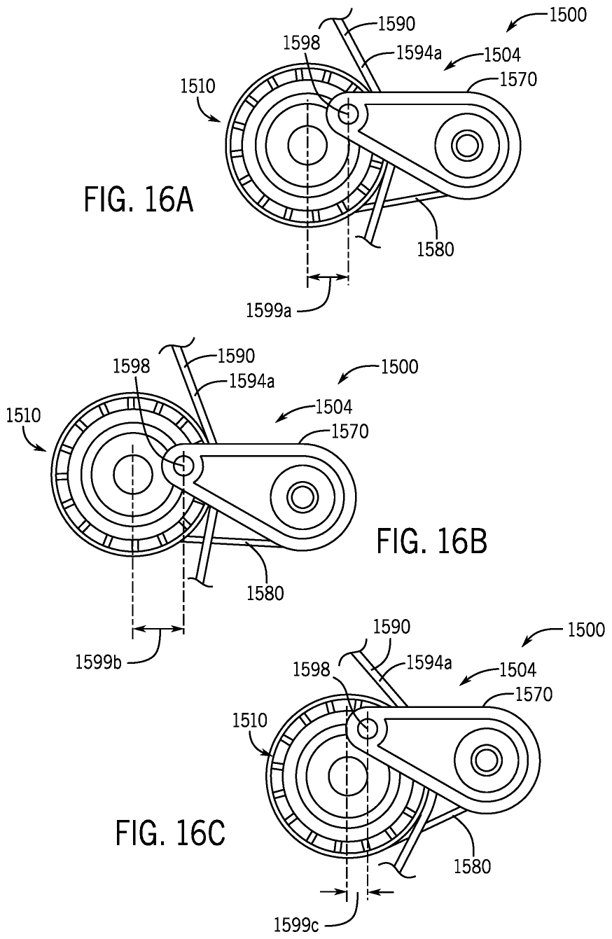

As shown in FIGS. 16A-16C, the subassembly 1510 may exert a force on the belt 1590 using different preload configurations of the biasing element based on the length of belt 1590. For example, the subassembly 1510 may exert a different force on the belt 1590 using a biasing element included therein and arranged in a loaded configuration that is tailored to bias the subassembly 1510 for movement in an amount required to tension the belt 1590 to the target tension based on the belt length.

To illustrate and with reference to FIG. 16A, the assembly 1500 is shown in a first configuration in which the belt 1590 has a nominal length. In the first configuration, the subassembly 1510 exerts a first force on the belt 1590 to create the target tension in the belt 1590. With reference to FIG. 16B, the assembly 1500 is depicted in a second configuration in which the belt 1590 has a measured length less than the nominal length, e.g., a “short” belt or negative length variation. In the second configuration, the subassembly 1510 exerts a second force on the belt 1590 to create the target tension in the belt 1590. With reference to FIG. 16C, the assembly 1500 is depicted in a third configuration in which the belt 1590 has a measured length greater than the nominal length, e.g., a “long” belt or positive length variation. In the third configuration, the subassembly 1510 exerts a third force on the belt 1590 to create the target tension in the belt 1590.

By tuning the tensioning device 1504 to the length of the particular belt with which it is associated, (e.g. notwithstanding the differing lengths of the belts 1590 in FIGS. 16A-16C), each belt 1590 may exhibit the same target tension. More generally, the belts of FIGS. 16A-16C may generally operate according to the same tension v. torque characteristic (depicted in the diagram of FIG. 22), despite the belt 1590 having different actual or measured lengths. In the first configuration of FIG. 16A, the subassembly 1510 may be positioned at an offset 1599a from a pivot point 1598 of the bracket assembly 1570. In the second configuration of FIG. 16B, the subassembly 1510 may be positioned at an offset 1599b from the pivot point 1598. The shorter belt in the second configuration causes the subassembly 1510 to rotate away from the bracket assembly 1570, and thus the offset 1599b is greater than the offset 1599a. And because the belt in the second configuration is shorter than the belt in the first configuration, it needs less force (from the subassembly 1510) in order to achieve the same tension. Further, in the third configuration of FIG. 16C, the subassembly 1510 may be positioned at an offset 1599c from the pivot point 1598. The longer belt in the third configuration causes the subassembly 1510 to rotate in towards the bracket assembly 1570, and thus the offset 1599c is less than the offset 1599a. And because the belt in the third configuration is longer than the belt in the first configuration, it needs more force (from the subassembly 1510) in order to achieve the same tension. As explained in greater detail below, this is facilitated by manipulating a biasing element of subassemblies 1510 to a loaded configuration that causes the subassembly 1510 to have the appropriate force (e.g., the first force, the second force, the third force of FIGS. 16A-16C, and so on) so that the belt 1590 is tensioned to the target tension.

Turning to FIG. 17, an exploded view of the tensioner device 1504 is shown. The tensioner device 1504 includes the subassembly 1510, the bracket assembly 1570, and the retainer 1580. The subassembly 1510 includes an engagement member 1512, such as a pulley, that has a surface 1513 adapted to engage a length or run of the belt 1590. The engagement member 1512 is associated with a bearing 1518 that is received within the engagement member 1512. The subassembly 1510 includes an upper sprocket arm 1524 and a lower sprocket arm 1530 that are engagable with the bearing 1518 at opposing sides of the engagement member 1512. The subassembly 1510 may have a pair of bushing 1536, 1538 that are engagable with a respective one of the first and second sprocket arms 1524, 1530, and facilitate a connection between the subassembly 1510 and the bracket assembly 1570, such as by establishing a pivot or rotational connection between each. The subassembly 1510 also includes a biasing element 1540, which may be a torsion spring, as shown in FIG. 17; however, other biasing elements and structures are contemplated herein. The biasing element 1540 includes a first end 1542 associated with the engagement member 1512 via the second sprocket arm 1530, and a second end 1544 associated with a sprocket 1546. The sprocket 1546 is a rotatable sprocket that includes a shaft 1547 receivable by the second sprocket arm 1530 to facilitate rotation relative thereto. A washer 1552 may receive an end portion 1548 of the shaft 1547 to secure the sprocket 1546 relative to the second sprocket arm 1530 without substantially constraining relative rotational movement. The sprocket 1546 may also include a groove 1551 about an exterior circumferential surface of the sprocket 1546 that is adapted to receive and secure the retainer 1580.

The bracket assembly 1570 includes a first bracket 1572 and a second bracket 1575. The first and second brackets 1572, 1575 may be connected to one another via a screw 1579; however, this is not required. The first bracket 1572 includes a connection point 1573 for pivotally engaging the subassembly 1510 and a mount 1574 for engaging the second bracket 1575. The second bracket 1575 includes a connection point 1576 for pivotally engaging the subassembly 1510, and a mount 1577 for engaging the first bracket 1575. The second bracket 1575 also includes a component 1578, which may be a protrusion or other anti-rotation feature that substantially inhibits rotation of the bracket assembly 1570, such as rotation of the bracket assembly 1570 about the screw 1579.

FIG. 17 also shows a sprocket 1560. The sprocket 1560 is associated with the bracket assembly 1570 and generally fixed related thereto. For example, the screw 1579 may optionally be used to secure the first and second brackets 1572, 1575 to one another, and to secure the sprocket 1560 to each of the brackets 1572, 1775. In the example of FIG. 17, the sprocket 1560 includes a post 1562 that may be received by and optionally pressed into the bracket, such as into the mount 1577. The post 1562 may define a friction or interference fit with the mount 1577 in addition to receiving a portion of the screw 1579. The sprocket 1560 also includes a groove 1564. The groove 1564 about an exterior circumferential surface of the sprocket 1560 that is adapted to receive and secure the retainer 1580.

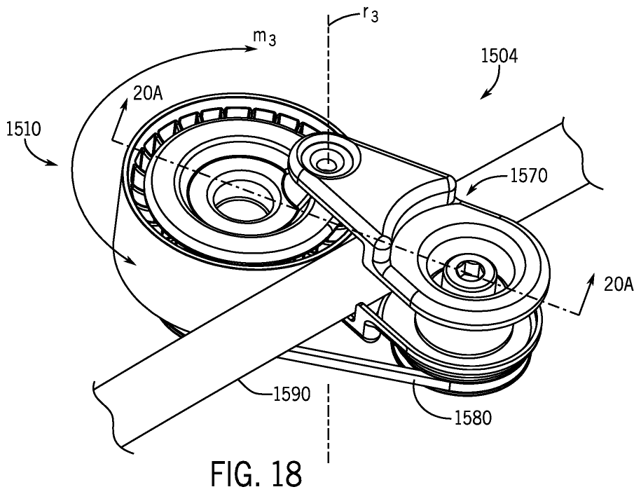

In an engaged configuration, the mount 1574 of the first bracket 1572 and the mount 1577 of the second bracket 1575 define a continuous and rigid connection between the first and second brackets 1572, 1575. Further in the engaged configuration (depicted in FIG. 18), a passage 1578 is defined by the subassembly 1510 and the mounts 1574, 1577. A portion of the belt 1590 (e.g., the first run 1594a) may be arranged within the passage 1578, thereby securing the belt 1590 within the tensioner device 1504.

FIG. 18 depicts a top isometric view of the tensioner device 1504 shown in a state where the tensioner device 1504 is tensioning a belt 1590. In FIG. 18, a run or length of the belt 1590 is secured within the tensioner device 1504. For example, the bracket assembly 1570 may extend from opposing sides of the engagement member 1512 and define a passage 1578 that surrounds the run of the belt 1590. In this regard, the tensioner device 1504 may be tuned to tension the belt 1590 based on the specific length of the belt trapped within the passage 1578. For example, as shown in FIG. 18, the belt 1590 is trapped within the tensioner device 1504. The subassembly 1510 can rotate or move along direction m₃, about the rotation axis r₃, and exert a force on the belt 1590 to tension the belt. The force can be specifically tuned to the measured length of the belt, as described herein.

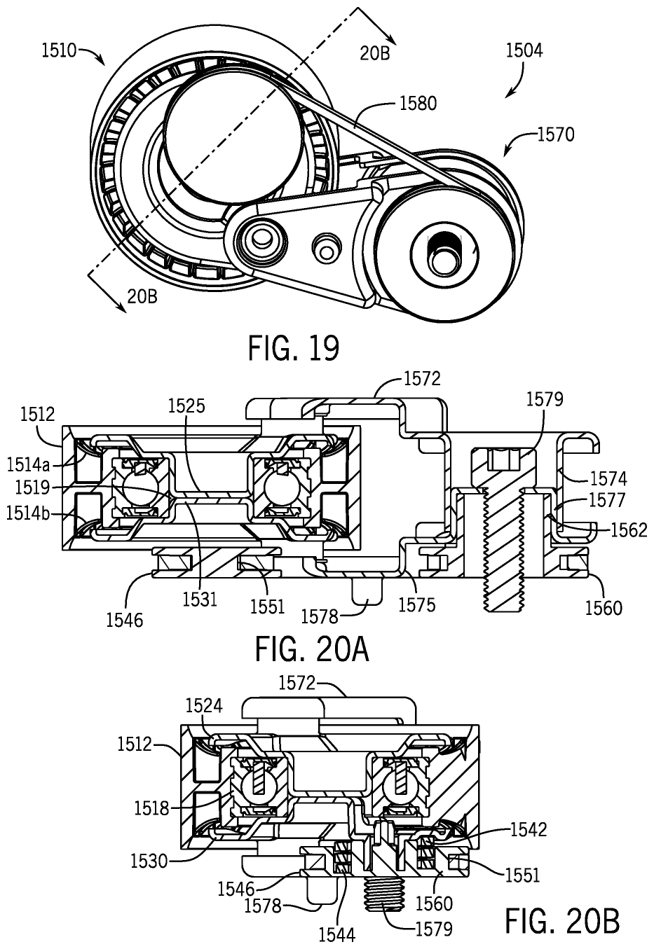

FIG. 19 depicts a bottom isometric view of the tensioner device 1504. In FIG. 19, the retainer 1590 is shown extending from the sprocket 1546 to the sprocket 1560. The sprocket 1546 is associated with the engagement member 1512 and configured to rotate relative thereto, and the sprocket 1560 is associated with the bracket assembly 1570 and generally fixed relative thereto. The biasing element 1540 is connected to the sprocket 1546 and the engagement member 1512 such that the biasing element 1540 stores or releases energy as the sprocket 1546 is rotated relative to the engagement member 1512. The retainer 1580 includes or defines a flexible elongate member between a first end of the retainer 1580, that is fixed to the sprocket 1546, and a second end of the retainer 1580, that is fixed to the sprocket 1560. In this regard, the retainer 1580 may be adapted to tune a preload force of the biasing element 1540, for example, by shortening or lengthening a span or length of the retainer 1580 between the sprocket 1546 and the sprocket 1560.

FIG. 20A depicts a cross-sectional view of the tensioner device 1504 of FIG. 18, taken along line 20A-20A of FIG. 18. Broadly, the subassembly 1510 may be substantially analogous to the first subassembly 110, described above in relation to FIGS. 1-14. In this regard, the engagement member 1512 may be molded over the bearing 1518. The upper sprocket 1524 and the lower sprocket 1546 may be received into an upper recess 1514a and a lower recess 1514b, respectively, of the engagement member 1512. The bearing 1518 has an interior surface 1519 that defines one or more passages that are adapted to receive a post 1525 of the upper sprocket 1524 and a post 1531 of the lower sprocket 1530 for a friction or interference fit therewith.

FIG. 20B depicts a cross-sectional view of the tensioner device 1504 of FIG. 19, taken along line 20B-20B of FIG. 19. In FIG. 20B, the first spring end 1542 is shown associated with the lower sprocket arm 1530, and the second spring end 1544 is associated with the sprocket 1546. In this regard, as the sprocket 1546 rotates relative to the lower sprocket arm 1530, the biasing element 1540 may be compressed. The sprocket 1546 may be manipulated into a rotational position such that the biasing element 1540 exhibits a known preload. This preload may cause or otherwise encourage the subassembly to rotate relative to the bracket assembly 1570. In particular, the preload may be calibrated to the specific or measured length of the belt that is trapped within the tensioner device 1504. For example, as described herein, the preload may be increased or decreased based on the belt 1590 deviating above or below, respectively, a nominal length of the belt 1590, so that notwithstanding the length deviation, the belt 1590 may exhibit a desired tension.

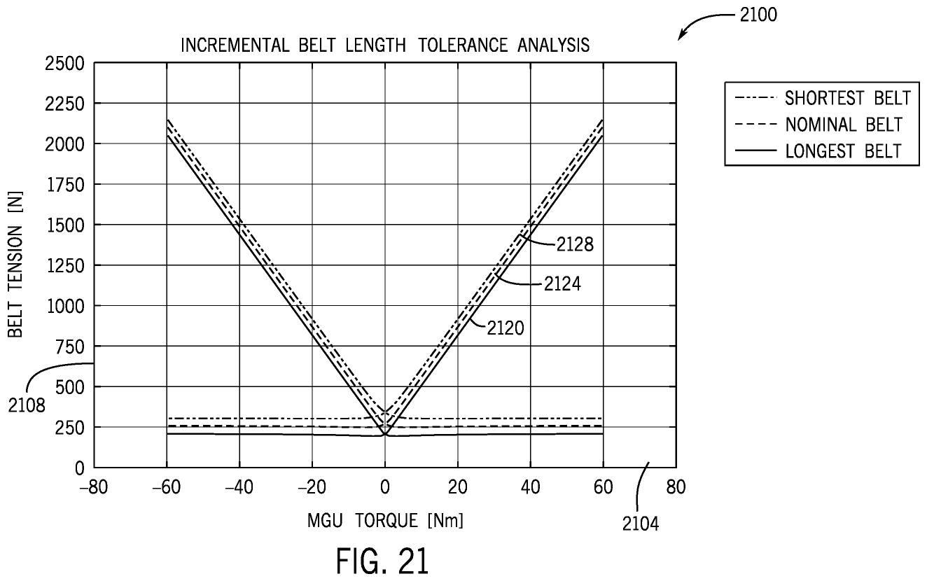

FIG. 21 depicts a diagram 2100 showing relationships between torque and belt tension for various belt lengths. In particular, the diagram 2100 illustrates a relationship between torque (as measured along torque axis 2104) and a belt tension (as measured along the belt tension axis 2108) for a conventional tensioner-type device that is not tunable to an actual or measured length of a belt. Typically in such cases, the tensioner-type device would be set with a preload in order to tension the longest tolerable belt. For example, a belt having a maximum positive deviation from a nominal length of the belt. The problem with this outcome is that for belts with shorter than the longest tolerable belt length, the preload is excessively high and may lead to premature component wear. This is shown in the example of FIG. 21, where a curve 2120 represents the performance of a “longest belt”, a curve 2124 represents the performance of a “nominal belt”, and a curve 2128 represents the performance of a “shortest belt.” As shown in the diagram 2100, the curve 2124 and the curve 2128 each show progressive higher values of tension for a given torque, as compared with the acceptable value of tension defined generally by the curve 2120. It will also be appreciated that the resulting tension would also be inappropriate in the case where the conventional tensioner-type device is set with a preload for the nominal belt length or the maximum negative deviation (short belt) length.

FIG. 22 depicts a diagram 2200 showing the relationship between torque and belt tension for various belt lengths with the belt tensioner devices of the present disclosure (e.g., the tensioner devices 104, 1504, and variations thereof). In particular, the diagram 2200 illustrates a relationship between torque (as measured along torque axis 2204) and a belt tension (as measured along the belt tension axis 2208) for the tensioner devices of the present disclosure. As described herein, the tensioner devices of the present disclosure are set with a preload in order establish the tension in the belt based on an actual or measured length of the belt. As such, despite variations from a nominal belt length, the belt may exhibit a consistent tension for a given value of torque. This is shown in the example of FIG. 22, where a curve 2220 represents the performance of a “longest belt”, a curve 2224 represents the performance of a “nominal belt” and a curve 2228 represents the performance of a “shortest belt.” As shown in the diagram 2200, each of the curves 2220, 2224, 2228 generally have the same or similar tension for a given value of torque, which may correspond to an acceptable or target design torque for a given system.

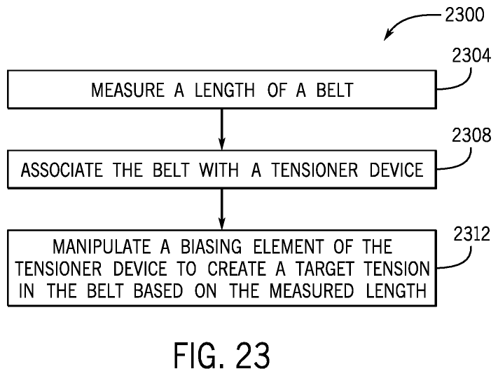

To facilitate the reader's understanding of the various functionalities of the examples discussed herein, reference is now made to the flow diagram in FIG. 23, which illustrates process 2300. While specific steps (and orders of steps) of the methods presented herein have been illustrated and will be discussed, other methods (including more, fewer, or different steps than those illustrated) consistent with the teachings presented herein are also envisioned and encompassed with the present disclosure.

In this regard, with reference to FIG. 23, process 2300 relates generally to a method for manufacturing a tensioner device and belt assembly. The process 2300 may be used with any of the tensioner devices and assemblies, for example, such as the tensioner devices 104, 1504 and/or assemblies 100, 1500, and variations and combinations thereof.

At operation 2304, a length of a belt is measured. For example and with reference to FIG. 1, a length of the belt 190 is measured. A variety of techniques may be used to measure the belt, including using a jig or other tooling. Laser measurements, along with other techniques, may be also be used. At operation 2304, a variation in the deviation of the belt 190 may therefore be determined, such as the where the belt 190 is shorter or longer than a nominal length.

At operation 2308, the belt is associated with the tensioner device. For example and with reference to FIG. 13, the belt 190 is associated with the tensioner device 104. The tensioner device includes an engagement member adapted to engage the belt to define a target tension in the belt in a static configuration, and a biasing element associated with the engagement member and a retainer. For example and with reference to FIG. 3, the tensioner device includes the engagement member 112 that is adapted to engage the belt 190 and define the target tension in the belt 194. The tensioner device 104 also includes the biasing element 140 and the retainer 180.

At operation 2312, the biasing element is manipulated into a loaded configuration relative to the engagement member and the retainer. The loaded configuration corresponds to the measured length of the belt in order to create the target tension in the belt when the belt is engaged by the tensioner device. For example and with reference to FIGS. 10 and 11, the biasing element 140 may be manipulated in a loaded configuration by rotating the sprocket 146 relative to the lower sprocket arm 130. The lower sprocket arm is generally fixed to the engagement member 112 and the first end 142 of the biasing element 140 is generally fixed to the lower sprocket arm 130. The sprocket 146 is generally rotatable relative to the lower sprocket arm 130 and the second end 144 of the biasing element 140 is generally fixed to the sprocket. The retainer 180 may be used to manipulate the sprocket 146 into a rotational position relative to the lower sprocket arm 130 that causes the biasing element 140 to be compressed by a predetermined amount. The compression of the biasing element 140 may thus store a predetermined amount of energy that may later be imparted as a preload force to appropriately tension the belt, based on the actual or measured length of the belt.

Other examples and implementations are within the scope and spirit of the disclosure and appended claims. For example, features implementing functions may also be physically located at various positions, including being distributed such that portions of functions are implemented at different physical locations. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A tensioner device for creating a target tension in a belt, the tensioner device comprising:
an engagement member having a surface adapted to engage the belt;
a biasing element having a first portion and a second portion, wherein the first portion of the biasing element is associated with the engagement member, and the second portion of the biasing element associated with a retainer of the tensioner device; and
a bracket assembly extending from opposing sides of the engagement member and encompassing a run of the belt, thereby securing the belt with the tensioner device,
wherein the biasing element is arranged with the tensioner device to store energy that is used by the engagement member to tension the belt.

2. The tensioner device of claim 1, further comprising the belt.

3. The tensioner device of claim 2, wherein:
the belt has a measured length; and
the biasing element is arranged in a loaded configuration relative to the engagement member and the retainer, the loaded configuration corresponds to the measured length of the belt to establish the target tension when the belt is engaged with the tensioner device.

4. The tensioner device of claim 3, wherein the first and second portions of the biasing element are adjustable relative to one another to define a preload of the biasing element that creates the target tension in the belt when the belt is engaged in the tensioner device.

5. The tensioner device of claim 4, wherein:
the biasing element is a torsion spring;
the first portion of the biasing element is a first end of the biasing element;
the second portion of the biasing element is a second end of the biasing element; and
the first and second ends of the biasing element are arranged at an angular offset from one another to define the preload in the torsion spring that is adapted to create the target tension when the belt is engaged with the tensioner device.

6. The tensioner device of claim 5, wherein the retainer is arranged with the tensioner device to maintain the angular offset of the first and second ends of the biasing element and define the preload.

7. The tensioner device of claim 1, wherein:
the tensioner device further comprises a subassembly that is rotatable relative to the bracket assembly, the subassembly including the engagement member and the biasing element; and
the retainer has a first end connected to the subassembly and a second end connected to a component that is positionally fixed relative to the bracket assembly.

8. The tensioner device of claim 7, wherein the retainer includes or defines an elongated flexible member between the first and second ends.

9. The tensioner device of claim 1, wherein the bracket assembly includes a first bracket and a second bracket that cooperate to trap the belt relative to the engagement member.

10. The tensioner device of claim 1, wherein:
the engagement member is a first engagement member configured to engage a first run of the belt;
the tensioner device further comprises a second engagement member configured to engage a second run of the belt, the first and second runs of the belt cooperating to define a continuous loop of the belt; and
the retainer extends from a component that is rotationally fixed relative to the second engagement member and to another component that is rotatable relative to the first engagement member for manipulating the biasing element relative to the first engagement member.

11. The tensioner device of claim 10, wherein the bracket assembly:
extends from opposing ends of each of the first and second engagement members;
encompasses each of the first and second runs of the belt, thereby securing the belt with the tensioner device; and
separates the first and second runs from one another with the tensioner device.

12. An assembly comprising:
a belt having a measured length; and
a tensioner device configured to engage the belt and define a target tension in the belt, wherein the tensioner device includes an engagement member, a biasing element, and a retainer, wherein the biasing element is arranged in a loaded configuration relative to the engagement member and the retainer that corresponds to the measured length of the belt to create the target tension in the belt when the belt is engaged by the tensioner device.

13. The assembly of claim 12, further comprising a bracket assembly enclosing a run of the belt with the engagement member.

14. The assembly of claim 13, wherein the engagement member is a pulley having a surface adapted to engage the belt, the pulley rotatable relative to the bracket assembly.

15. The assembly of claim 14, further comprising a sprocket that is rotatably associateable with the pulley and holding the biasing element.

16. The assembly of claim 15, wherein the biasing element is a torsion spring seated in the sprocket, the torsion spring having a first end associated with the pulley and a second end associated with the retainer.

17. The assembly of claim 16, wherein the loaded configuration corresponds to an angular arrangement of the first and second ends of the torsion spring that are adapted to define a deflection and an effective spring rate of the torsion spring for creating the target tension in the belt.

18. The assembly of claim 13, wherein the bracket assembly is adapted to trap a first run of the belt and a second run of the belt with the tensioner device, the first and second runs defining a continuous loop of the belt.

19. The assembly of claim 18, wherein:
the engagement member is a first engagement member pivotally engaged with the bracket assembly;
the tensioner device further comprises a second engagement member pivotally engaged with the bracket assembly; and
the retainer spans the bracket assembly and is:
moveably associated with the first engagement member, and
fixedly associated with the second engagement member.

20. A method of manufacturing a tensioner device and belt assembly, the method comprising:
measuring a length of a belt;
associating the belt with a tensioner device, the tensioner device including an engagement member adapted to engage the belt to define a target tension in the belt, and a biasing element associated with the engagement member and a retainer; and
manipulating the biasing element into a loaded configuration relative to the engagement member and the retainer that corresponds to the measured length of the belt to create the target tension in the belt when the belt is engaged by the tensioner device.

21. The method of claim 20, wherein the operation of measuring occurs after the length of belt is stabilized from a process of forming the belt.

22. The method of claim 20, further comprising determining a preload for the biasing element that is adapted to create the target tension in the belt based on the measured length of the belt.

23. The method of claim 20, wherein the operation of manipulating further comprises defining an angular position of the biasing element relative to the engagement member and the retainer to define a preload in the biasing element.

24. The method of claim 23, wherein the biasing element comprises a torsion spring, the torsion spring having first and second ends that are positioned at an angular offset from one another to define the angular position of the biasing element.

25. The method of claim 20, further comprising providing the tensioner device.

26. The method of claim 25, wherein the tensioner device further comprises a bracket assembly extending from opposing sides of the engagement member and surrounding a run of the belt with the engagement member, thereby securing the belt with the tensioner device.

27. The method of claim 26, wherein the tensioner device further comprises a retainer associated with the biasing element, the retainer being further associated with a component of the tensioner device that is secured relative to the bracket assembly.
